(19) United States
(12) Patent Application Publication
(10) Pub. No.: US 2008/0301013 A1
(43) Pub. Date: Dec. 4, 2008

(54) SYSTEM AND METHOD FOR EVALUATING THE FISCAL CONDITION OF COMPANIES

(75) Inventors: Michael J. Markowski, Osprey, FL (US); Larry Napier, Thompsons Station, TN (US)

Correspondence Address: WOLF GREENFIELD & SACKS, P.C., 600 ATLANTIC AVENUE, BOSTON, MA, 02210-2206, US

(73) Assignee: Stockdiagnostics.com, Inc., Osprey, FL (US)

(21) Appl. No.: 11/868,068

(22) Filed: Oct. 5, 2007

Related U.S. Application Data
(63) Continuation of application No. 10/379,374, filed on Mar. 4, 2003, now abandoned.
(60) Provisional application No. 60/362,296, filed on Mar. 4, 2002.

(51) Int. Cl. G06Q 10/00

(52) U.S. Cl. 705/30

(57) ABSTRACT

A system and method are provided for analyzing the fiscal condition of a company based on publicly available information to identify problematic situations. In one embodiment, the relation between two financial indicators is examined. These indicators may be, for example, the earnings-per-share of a company and the operating cash flow-per-share of the company. If record high earnings are achieved yet operating cash-flow is low or negative, the company may be in financial distress.

### RELATED APPLICATIONS

This application is a continuation of prior application Ser. No. 10/379,374, filed Mar. 4, 2003, which in turn claims benefit under Title 35, United States Code, §119(e) of U.S. Provisional Application Ser. No. 60/362,296, filed Mar. 4, 2002, entitled “SYSTEM AND METHOD FOR EVALUATING THE FISCAL CONDITION OF COMPANIES,” by Michael Markowski.

### FIELD OF THE INVENTION

This invention relates to the field of financial analysis and, in particular, to analyzing the fiscal condition of a company based on publicly available information, such as, for example, to identify problematic situations.

### BACKGROUND OF THE INVENTION

Determining the financial health of a public company is important for a number of reasons. First, potential investors would like to know the fiscal condition of a company in order to assess the company's prognosis, so as to minimize risk when purchasing, or selling short, securities of the company, or buying or selling options. Investors who hold a security would like to assess the risk of continuing to hold the security versus selling the security. Also, vendors and contractors performing work for a company may wish to reduce the risk that the company will be incapable of paying upon delivery or completion. This information could also be useful to other companies in the same market space to evaluate their competitors, and to those seeking to evaluate risk in potential partnerships or mergers, and to identify acquisition targets, as well as for other purposes.

Thus, investors, analysts, and others often examine a company's financial statements to determine the fiscal condition of the company. Typically, analysts may look at information such as earnings (profits) and sales to determine if a company is financially strong. For example, if a company's earnings and sales are high, analysts may be led to believe that the company is fiscally sound. Analysts may also research historical patterns of financial data to determine if a company's financial data matches one of these patterns.

However, events of recent (and not-so-recent) times have shown that these conventional methods of financial analysis can be very misleading, particularly when a company is reporting good sales and revenues and the cost of achieving those sales is masked, obscured, or simply not probed in depth. For example, due to certain accounting practices, companies may be able to hide large financial losses from the public while reporting record earnings. The stocks of these companies may be reported as good buys while the companies are reporting record amounts of negative cash flow from operations. A need thus exists for a method and system of recognizing indicators of a company's fiscal condition, particularly (but not limited to) impending problematic circumstances before total collapse occurs. Preferably, such a method and system require only publicly available information as input.

### SUMMARY OF THE INVENTION

Financial problems usually do not arrive overnight for public companies. Most often they develop over a period of at least several months. In attempting to understand how a company could arrive at a point of fiscal difficulty—even collapse—without signs of serious problems having been observed earlier, it has been determined that there is a previously unrecognized relationship pattern between earnings and operating cash flow that often portends great fiscal stress. This stress is often man-made, because in most cases it stems from a manipulation of a company's earnings by management in order to maximize its share price in the stock market. Often, this relationship pattern appears to have identified companies that will go bankrupt or have their stock value drop precipitously. We call this pattern the “EPS Syndrome” or the “Cashless Earnings Syndrome.” Identification of this syndrome and other cash-flow-related patterns is an objective of the herein-disclosed method and system.

According to one aspect of the invention, a method for evaluating the financial health of a public company is provided, comprising determining a relation between a value of a first financial metric over a first period of time and second financial metric over a second period of time. In one embodiment, the first and second periods of time are the same period of time. In this embodiment, the first and second periods of time may be, for example, a same fiscal quarter. In another embodiment the first and second periods of time partially overlap. In yet another embodiment the first and second periods of time are separate periods of time. In this embodiment, the first and second period of time may be separate fiscal quarters. The first financial metric may be, for example, earnings of the company and the second financial metric may be, for example, operating cash flow of the company.

In one embodiment, the relation is determined between the earnings per share of a company and the operating cash flow per share of the company.

Preferably, the method includes the act of determining if the earnings over the first period of time are record earnings over the company's life or at least a predetermined substantial period of time, and determining after a period of record earnings whether the operating cash flow of the company of a second period of time is negative by a value greater than the earnings.

In one embodiment, the method may also include determining an amount of debt of the company and evaluating the relation based on the amount of debt.

In another embodiment, the method may also include determining a borrowing ability of the company and evaluating the relation based on the company's borrowing ability.

In yet another embodiment, the method may also include determining an ability to raise cash via a public securities offering of the company and evaluating the relations based on the company's ability to raise cash.

Preferably, the method also includes displaying a graphical representation of the fiscal metrics and optionally displaying a graphical representation of the relationship between the metrics. The graphical representation can be in the form of a histogram or a line graph. The graphical representation may also include a reference legend which shows at least one pattern of earnings and operating cash flow indicative of a category of financial health.

In one embodiment, the fiscal data may be received over a communications network and then may be displayed in a language selected from among a predetermined set of a plurality of available languages.

In any of the foregoing embodiments, the methods, or any desired parts of them, may be computer-implemented.

According to another aspect of the invention, a system (which may be computer-implemented) is provided for receiving financial data of a company and for determining, in response, to the financial data of the company, a relation between a value of a first financial metric over a first period of time and a value of a second financial metric over a second period of time.

In one embodiment, the system may also display a graphical representation of the first and second financial metrics and the relation. The graphical representation may be part of a dynamically generated HTML or XML document, or the like, and the financial metrics may be displayed in the form of a histogram or a line graph, or in other convenient form. The graphical representation may also include a reference legend which shows at least one pattern of earnings and operating cash flow indicative of a category of financial health.

Preferably, the system includes at least one data feed for providing the value of the first financial metric over the first period of time and the value of the second financial metric over the second period of time.

Additionally, the system may include a computer server for providing access to the values of the first and second financial metrics and the graphical representations.

In another aspect of the invention a computer-readable medium encoded with instructions for execution on a computer system is provided. The instructions when executed perform a method comprising an acts of determining a relation between a value of a first financial indicator over a first period of time and second financial indicator over a second period of time.

In one embodiment, the first financial indicator may be earnings of the company and the second financial indicator may be operating cash flow of the company.

In another embodiment, the method further comprises an act of determining a relation between earnings per share of stock of the company over a first period of time and operating cash flow per share of stock of the company over a second period of time. Additionally, the method may further comprise an act of determining if the earnings of the company over the first period of time are record earnings over a predetermined substantial period of time and if the operating cash flow of the company over a second period of time is negative by a value greater than the earnings.

In another aspect of the invention a method is provided, in a computer system having a display, of performing acts of displaying, on the display, earnings per share of a preselected company over a period of time and displaying, on the display, operational cash flow of the company over the period of time. The method may further include an act of displaying, on the display, a fiscal health rating of the company, based on the earnings per share and the operational cash flow per share of the company.

Additionally, the method may further comprise an act of displaying, on the display, an amount of debt of the company and an act of displaying a reference legend that includes patterns of earnings per share and operation cash flow per share for different categories of financial health.

These and other features will be better understood from the detailed description below, which should be read in conjunction with the accompanying drawings.

### BRIEF DESCRIPTION OF THE DRAWINGS

The foregoing and other features and advantages of the present invention will become more fully understood and appreciated from the detailed description below, which should be read in conjunction with the accompanying drawings, wherein like numerals refer to like elements.

In the drawings:

FIGS. 1A-1C are graphical depictions of various financial data relevant to a company's performance as a function of time;

FIG. 2 is a flow chart illustrating a method of determining a company's fiscal condition according to one embodiment of the invention;

FIG. 3 is a flow chart illustrating a method of determining a company's fiscal condition according to another embodiment of the invention;

FIG. 4 is block a diagram illustrating a client/server architecture according to one embodiment of the invention;

FIGS. 5A-5C are diagrams with illustration of a display for displaying information about a company according to one embodiment of the invention;

FIG. 6 is a diagram with illustration of a display for displaying information about an industry according to one embodiment of the invention;

FIG. 7 is a diagram with illustration of a display for displaying information about patterns of financial health based on a relation between one or more financial metrics;

FIGS. 8A-8C are a diagrams with illustrations of displays for displaying representations of a company's fiscal health; and

FIG. 9 is a diagram of a computer system on which various embodiments of the present invention may be implemented.

### DETAILED DESCRIPTION

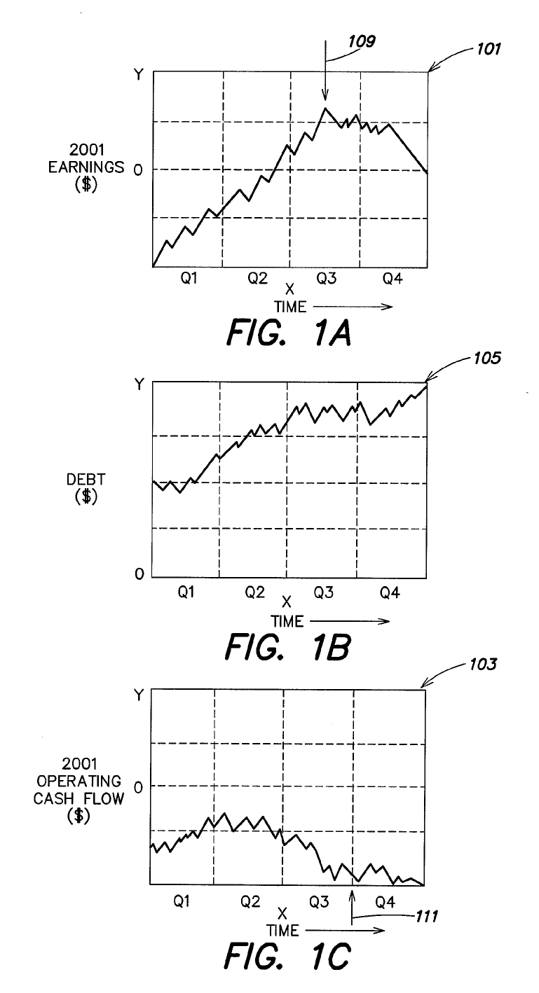

Analyzing a company's published financial statements can provide one with valuable information about the company's financial condition. More particularly, by determining a relationship between two or more published financial metrics and analyzing these metrics in parallel, it is possible to determine certain aspects of the fiscal condition of the company, as well as forge predictions or assist others who forge predictions or projections about the future status of the company and/or its securities. Such determinations and predictions may be made even if the company is engaged in aggressive accounting practices, such as hiding large investment losses off of its books of accounts, by using parameters that must be reported, according to regulatory and accounting requirements. Referring to FIGS. 1A-1C, graphs are shown for several financial metrics that may be used to evaluate the fiscal condition of a company, over a period of time. Graph 101 in FIG. 1A shows the earnings of a hypothetical company (PUBLICCO) over the four quarters of a fiscal year, e.g., 2001. Graph 103 in FIG. 1C shows the operating cash flow of the company over the same or a related period of time. Typically, cash flow consists of three parts: operating cash flow, investment cash flow, and financing cash flow. Operating cash flow, also referred to as operational cash flow, is the flow of cash to and from a company as a result of normal sales and operations. For example, operating cash flow may reflect balance sheet and income statement items that show a change in a company's cash position. Positive operating cash flow may result when a company generates more cash than it is spending. Negative operating cash flow may result when a company is spending more cash than its business is generating and may cause a company to utilize reserve investments or outside financing to make up the difference. Investment cash flow is the flow of cash resulting from a company's investments. Investment cash flow may factor in the investments of the company, securities owned by the company and the fixed assets of the company. Financing cash flow is the flow of cash as a result of borrowings, sale of securities, and dividends paid.

Since operating cash flow focuses on the costs and profits of operating the business, it is often used instead of earnings to determine a company's ability to generate cash (e.g., to pay creditors). However, prior art methods of analysis have failed to recognize that a company's fiscal condition may be determined, in part, by looking for relationships between operating cash flow and earnings.

In one embodiment of the invention, a relationship is formed and examined between earnings and operating cash flow and provides an indicator as to whether a company may be in or approaching financial trouble. Referring now to the flow chart of FIG. 2, which may represent logic executed on a computer (not shown), it is determined if a company has reported positive record earnings for a period of time (act 102). The positive record earnings may be record earnings in a quarter of a fiscal year, multi-quarter periods in a fiscal year, a fiscal year, or in any other substantial period of time. In addition, the earnings may be a one-year record, a five-year record, or a record over any other substantial period of time. If record high earnings are observed in the period, operating cash flow is then considered in the same period (act 104). Thus, for example, if the earnings for the second quarter of a fiscal year are higher than the earnings for the second quarter of each of the previous four years, then operating cash flow is considered. If the operating cash flow is weak (for example, if it is negative and of a magnitude in excess of the earnings of the previous period), the company may be in financial trouble and a signal of that circumstance is provided. This situation implies that a company is at or close to its maximum earnings potential, and that such earnings were achieved at a cost that the earnings cannot repay. Since the company is already near its maximum earnings, it probably cannot improve profitability by increasing revenue. Thus, the company is forced into the difficult position of maintaining sales levels while cutting costs. While sometimes possible, often it is not. This situation is known as the Cashless Earnings Syndrome (CES), sometimes referred to as the Earnings-Per-Share (EPS) Syndrome, and indicates that a company may be in a critical financial condition (act 108). If record high earnings are not observed, more information may be required to determine the fiscal condition of the company (act 106). If record high earnings are observed, but weak (i.e., large and negative) operating cash flow is not, then the relationship does not indicate any immediate danger for the company (act 110). Another example of Cashless Earnings Syndrome is shown below in Table 1, indicating earnings-per-share (EPS) and operating cash flow-per-share (OPS) over a five-year period for a hypothetical company, PUBLICCO. OPS may be calculated by dividing a company's operating cash flow by the total number of common shares outstanding. As can be observed, PUBLICCO achieved record high earnings of twenty-two cents per share over a five-year period in the fourth quarter of 2001. In this quarter, the operating cash flow of the company was negative twenty-three cents per share. Thus, the operating cash flow was negative and of a magnitude greater than the earnings, indicating a potential CES signal.

However, it is often observed that a company will tend to have higher earnings or lower operating cash flow in a particular quarter, due to the seasonal nature of the industry in which it is in.

In order to prevent such quarters from providing a CES signal which lacks strong problem-indicating characteristics, a filter optionally may be applied to screen out potential CES signals which are not “strong.” For example, one can calculate the EPS for each fiscal period and the earnings for the year-to-date. If the initial CES signal was detected in the fourth quarter of 2001, then one may calculate the EPS over one or more of the first two quarters of 2001, the first three quarters of 2001 and the entire fiscal year. In order for the CES signal to be considered valid, all of these earnings calculations must be record positive earnings for their respective periods or the CES signal is ignored (i.e., screened out). For example, a filter may require that the earnings over the first two quarters of 2001 be higher than the earnings for the first two quarters of the previous four years. The CES signal is only valid (i.e., passes the filter) if all of the earnings calculations for the selected parts of that year or the entire year are also record highs for their respective periods of time.

Another way to reduce seasonal companies from triggering false CES signals, if record high earnings are detected in the same quarter as negative operating cash flow in excess of the earnings, is to determine if any three (or other selected number) consecutive quarters in the past had negative operating cash flow. If such consecutive quarters are found that have negative operating cash flow, but the operating cash flow calculated for the entire fiscal years in which those quarters occurred is positive, then the CES signal is not valid (i.e., is screened out).

Yet another way to reduce the seasonality of certain companies from generating “false positives”, in the case where a potential CES signal is initially detected, may be used for companies where multiple CES signals are detected in different fiscal years. In this case, if the operating cash flow calculated over the entire fiscal year is positive for the two most recent years in which a CES signal was detected, then the CES signal is considered not valid.

It is also desirable to determine if companies for which a CES signal has been detected have showed signs of recovery. This may be determined by examining the most recent fiscal year in which a CES signal was detected. If the operating cash flow and earnings calculated over the entire fiscal year are both positive, then the company has achieved partial remission. If in the next subsequent year a company which achieved partial remission in the previous year, shows positive operating cash flow and positive earnings calculated over the entire fiscal year, then the company is said to have achieved full remission.

Thus, using this method, a company may be given one of four designations. These designations may be indicated by color in a graphical display. For example, a company in which a CES signal has not been detected may be illustrated with a green color. A company in which the CES signal has been detected may be illustrated with a red color. A company which has achieved partial remission may be illustrated with a yellow color. A company which has achieved full remission may be illustrated with a purple color. It should be appreciated that the CES signal or recovery therefrom may be indicated in a variety of different ways in addition to using different colors, and the invention is not limited in this respect.

TABLE 1

| | Q1 | Q1 | Q2 | Q2 | Q3 | Q3 | Q4 | Q4 |
|---|---|---|---|---|---|---|---|---|
| | earnings | OCF | earnings | OCF | earnings | OCF | earnings | OCF |
| | per share | per share | per share | per share | per share | per share | per share | per share |
| 2001 | $0.16 | $0.03 | $0.17 | $−0.06 | $0.21 | $−0.15 | $0.22 | $−0.23 |
| 2000 | $0.14 | $0.04 | $0.15 | $−0.05 | $0.15 | $0.07 | $0.15 | $0.07 |
| 1999 | $0.14 | $0.03 | $0.14 | $0.03 | $0.15 | $0.04 | $0.15 | $0.05 |
| 1998 | $0.11 | $0.03 | $0.11 | $0.04 | $0.12 | $0.03 | $0.13 | $0.03 |
| 1997 | $0.10 | $0.03 | $0.10 | $0.01 | $0.11 | $0.01 | $0.12 | $0.01 |

### PUBLICCO

As illustrated in FIG. 1A, the earnings of PUBLICCO shown in graph 101 reach a record high in the third quarter (Q3), indicated by arrow 109. As shown in graph 103 of FIG. 1C, the operating cash flow of the company in this quarter is negative and in excess of the earnings of the company, as indicated by arrow 111. The best timing relationships to use (i.e., the time delay, if any, between operating cash and earnings) may depend on patterns and practices in the relevant industry and will have to be found either empirically or from analysis of historical data. The relationship between graph 101 and graph 103 is illustrative of the Cashless Earnings Syndrome, signifying a possible problem for the company. The earnings and operating cash flow used to analyze the relationship may be the total earnings and operating cash flow of the company or the per-share earnings and operating cash flow. Using the earnings-per-share and operating cash flow-per-share facilitates comparisons between different companies.

A company may be given an OPS rating which ranks the company (e.g., on a scale of 1 to 8 based on its OPS position). Using the 1 to 8 scale, for example, a rating of 1 may indicate that the company is “low risk”, while a rating of 8 may indicate that the company is “high risk” (or the scale might be reversed). The OPS rating looks at the company's reported OPS in each of the most recent four fiscal quarters. If the company reported positive OPS calculated over the entire most recent four quarters, it is given a “positive” OPS rating between from 1 to 4. The positive OPS ratings are determined as follows. If the company reported positive OPS in each of the most recent four quarters, it is given an OPS rating of 1. If the company reported three quarters of positive OPS and one quarter of negative OPS in the most recent four quarters it is given an OPS rating of 2. If the company reported two quarters of positive OPS and two quarters of negative OPS in the most recent four quarters, it is given an OPS rating of 3. If the company reported one quarter of positive OPS and three quarters of negative OPS, it is given an OPS rating of 4.

If the company reported negative OPS over the entire most recent four quarters, it is given a “negative” OPS rating of 5 to 8. The negative OPS ratings are calculated as follows. If the company reported three quarters of positive OPS, but one quarter of negative OPS in the four most recent quarters, it is given an OPS rating of 5. If the company reported positive OPS in two quarters and negative OPS in two quarters in the four most recent quarters, it is given an OPS rating 6. If the company reported positive OPS in one quarter and negative OPS in three quarters of the four most recent quarters, it is given an OPS rating of 7.

If the company reported negative OPS in each of the four most recent quarters, it is given OPS rating of 8.

If a company's OPS rating has dropped significantly over a certain period of time, for example, two, three, or more quarters, a warning may be issued that the company is in poor fiscal health, even though it has not yet been diagnosed with CES.

If a company is diagnosed with CES within the last four quarters, then its OPS rating may be suspended. The reason for suspending the OPS rating is that a company in severe financial hardship may experience a sudden increase in OPS due to the company cutting costs, selling assets, and reducing debt. A positive OPS after a company has been diagnosed with CES indicates that the company is at least aware of the problem and is attempting to do something about it.

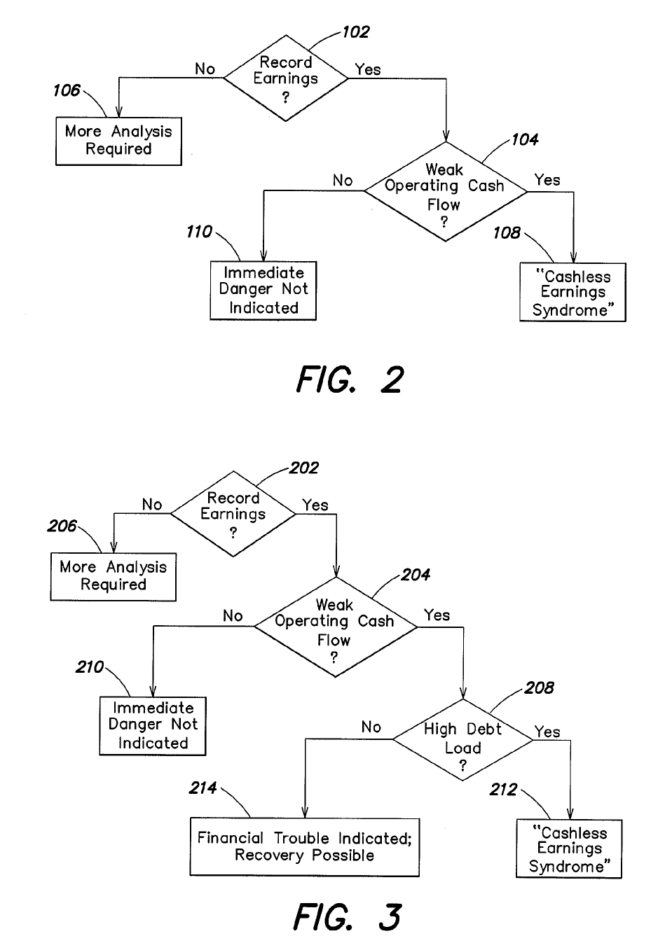

Other financial circumstances such as a company's balance sheet or debt-to-equity ratios may affect the significance of the CES indicator signal. For example, a company experiencing Cashless Earnings Syndrome may be able to borrow money or have a securities offering in order to meet expenses. However, if the company already has a high debt load, it is unlikely that they will be able to borrow large sums of money. Thus, debt is another financial metric that may affect the interpretation of the Cashless Earnings Syndrome signal and the ultimate fiscal outcome for the company. Graph 105 of FIG. 1B shows a high debt load, indicating that the financial condition of that particular company may be more critical than that of a company with a low debt load. Further, as stated above the availability of a cash infusion from a securities offering may help determine the outcome for the company, as well. Referring to the flow chart of FIG. 3, a third financial metric (e.g., debt load) may be factored into the previously described relationship. Again, if record earnings are observed in a given period (act 202), operating cash flow is considered (act 204). However, if operating cash flow is weak, as described above, the third financial metric is considered. In this example, debt (act 208) is given as a third financial metric; however, other metrics may also affect the relationship. In this case, if debt load is high, it is likely that the company will not be able to borrow its way out of financial difficulty, and a CES signal is provided (act 212). If the company has low debt, recovery may be possible, but a signal is provided that indicates the company is experiencing financial difficulty (act 214).

In developing this method of analysis, data for over fifteen hundred public companies in the United States were found to have exhibited the Cashless Earnings Syndrome over a recent five-year period. Only about thirty percent have been able to achieve two consecutive fiscal years of positive earnings and operating cash flow after generating a CES signal. About twenty percent have made it through one year and the passage of more time will be required before the outcome is known for them. About fifty percent have experienced severe financial trouble. That is, their stock has dropped below one dollar per share, they have completely gone out of business, or they have entered bankruptcy.

It should be understood that financial metrics other than earnings and operating cash flow may be examined together to determine the fiscal health of companies. For example, share price could be examined with operating cash flow. Alternatively, gross margins and earnings could be examined together or receivables and revenue could be examined together. Software may allow the user to select the metrics to be examined in relation to each other.

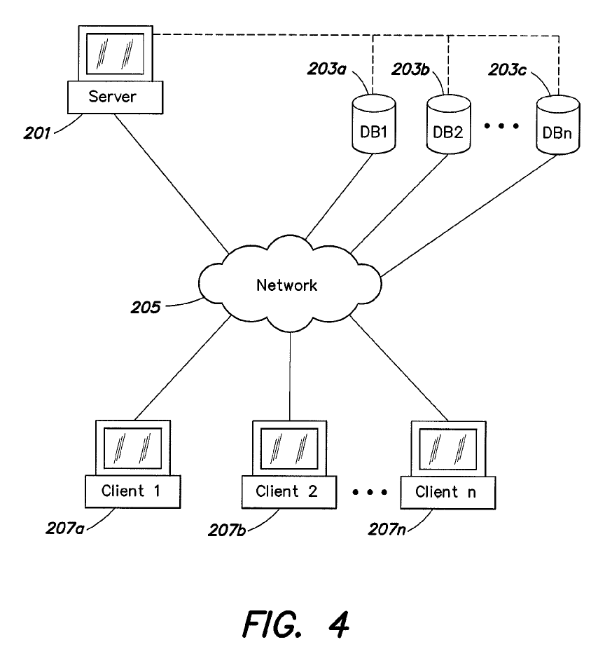

The financial metrics may be received and their relationship may be analyzed and reported via a computer communications network. In one embodiment, illustrated in FIG. 4, a data transmission architecture for reporting this information is used. Server 201 receives financial metrics about companies from databases 203a-203n or other sources. Databases 203 may be populated with this data by one or more data feeds (not shown). Databases 203 may be directly connected to server 201 or may be connected to server 201 through network 205. Network 205 may be any suitable combination of networking hardware or software. Server 201 receives financial metrics data about a company from databases 203, analyzes the information, and formats the information. Clients 207a-207n also connect to server 201 through network 201. Clients 207 receive the formatted information from server 201 and display the results of the analysis. Server 201 may also be capable of displaying these results.

In one embodiment, server 201 may be a World Wide Web (WWW) server and the network 205 may be the global Internet. Of course, network 205 may be or include a private network, corporate intranets, local area networks (LANs), wide area networks (WANs), extranets, and the like. Server 201 may transmit documents in HTML or XML format or any other format suitable for display in a web browser. Clients 207 may use a web browser such as Internet Explorer, made by Microsoft Corporation or Navigator made by Netscape Corporation, to send queries and data to, and receive information from, server 201 and display it to a user, using a standard data transfer protocol or suite of protocols, such as TCP/IP.

In another embodiment, clients 207 may use an independent software application to connect to server 201, receive the information, and display the results. This independent application may use a standard data transfer protocol or a proprietary data transfer protocol.

It should be noted that a client/server architecture is given only as an example of one network architecture that could be used to transfer data. Other architectures, such as a peer-to-peer architecture, or any other suitable architecture, may be used. Additionally, server 201 could push information onto clients 207, or clients 207 could pull information from server 201, and clients could analyze, format, and display the necessary data on their own. Client could also pull this information directly from databases 203. Numerous other ways of transferring data will readily occur to one skilled in the art and are intended to be within the spirit and scope of the invention.

The methods described above for receiving and analyzing financial information to, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBAL, etc., or any of a variety of combinations thereof. The computer-readable medium on which such instructions are stored may reside on one or more of the components of the computer network described in FIG. 4, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

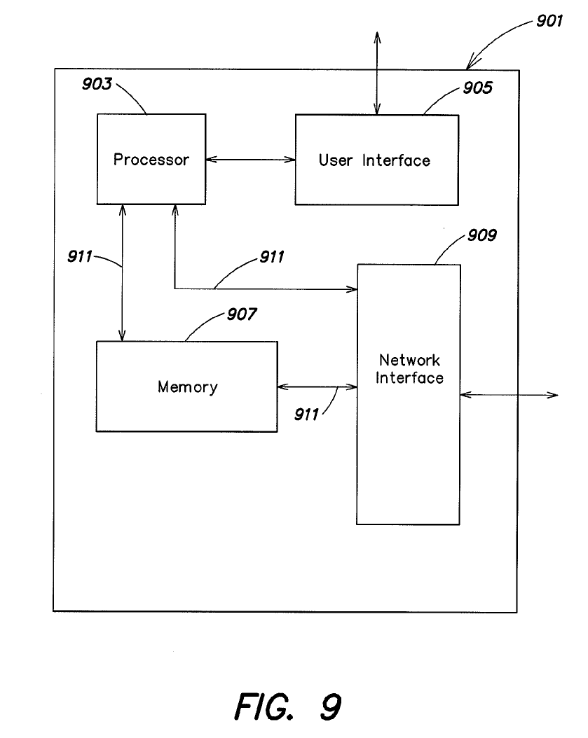

FIG. 9 is an example of a computer system 901 suitable for use in network 205 of FIG. 4. Computer system 901 may serve as either a client, server, or other type of computer in the network. Computer system 901 includes a processor 903, a user interface 905, a memory 911, and a network interface 909. These components may be interconnected via a plurality of communication buses 911. Computer system 901 may also include other components which are not illustrated in FIG. 9.

Computer system 901 and components thereof, may be implemented using software (e.g., C, C#, C++, Java, or a combination thereof), hardware (e.g., one or more application-specific integrated circuits), firmware (e.g., electrically-programmed memory) or any combination thereof. One or more of the components of computer system 901 may reside on a single system (e.g., a single server or a single client), or one or more components may reside on separate, discrete systems (e.g., multiple servers or multiple clients). Further, each component may be distributed across multiple systems, and one or more of the systems may be interconnected.

Computer system 901 may be a general-purpose computer system that is programmable using a high-level computer programming language. Computer system 901 may be also implemented using specially programmed, special purpose hardware. In computer system 901, processor 903 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

User interface 905 is an interface between a human user and a computer that enables communication between a user and a computer. Types of UIs include a graphical user interfaces (GUI), a display screen, a mouse, a keyboard, a keypad, a track ball, a microphone (e.g., to be used in conjunction with a voice recognition system), a speaker, a touch screen, a game controller (e.g., a joystick) etc, and any combinations thereof.

Memory 907 includes any type of volatile or non-volatile memory. For example, Memory 907 may include a main memory, which may be implemented as RAM or SRAM. The main memory may also have a cache. It should appreciated that processor 903 may also have a local processor cache. Memory 907 may also include a secondary memory such as a magnetic disk drive. Additionally memory 907 may include a ROM, EPROM, or EEPROM for storing computer code or other data. Memory 907 may also include an optical disk drive or magnetic tape drive, which is capable of reading and writing various types of optical media (e.g., compact discs, digital video discs, etc.), that may be used for back-up operations. Memory 907 may store compute code which, when executed, performs analysis of financial data and displays results of such analysis to a user.

Network interface 909 may be used to interface with a computer network, such as network 205 in FIG. 4. When connected to a computer network, network interface 909 allows computer system 901 to communicate with other systems. Network interface 909 may be any type of network interface and may use any type of network protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. It should further be appreciated that any of the displays or GUIs described herein may be implemented on a computer system, such as computer system 901.

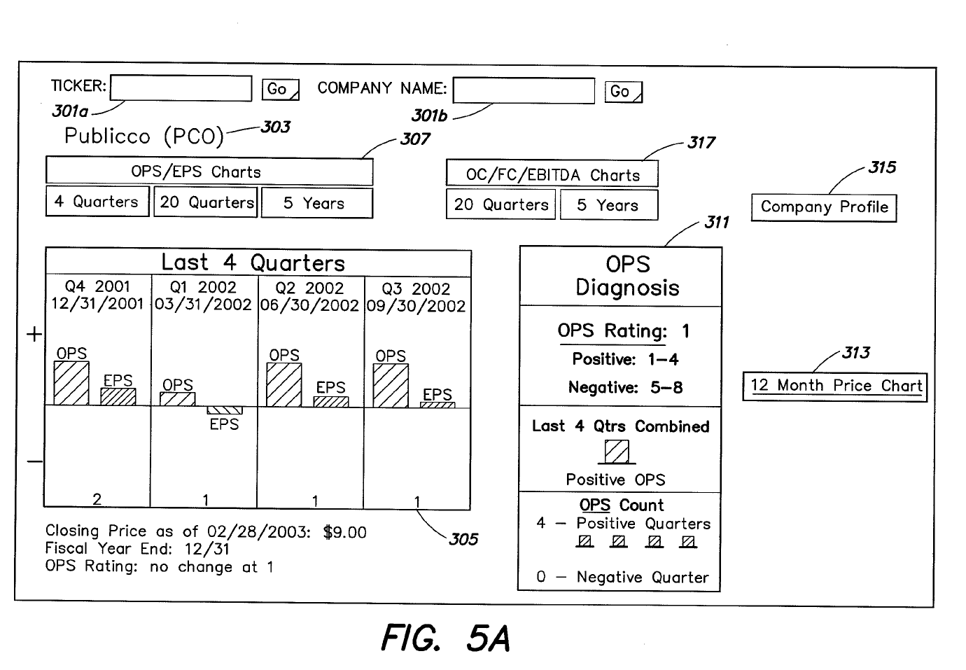

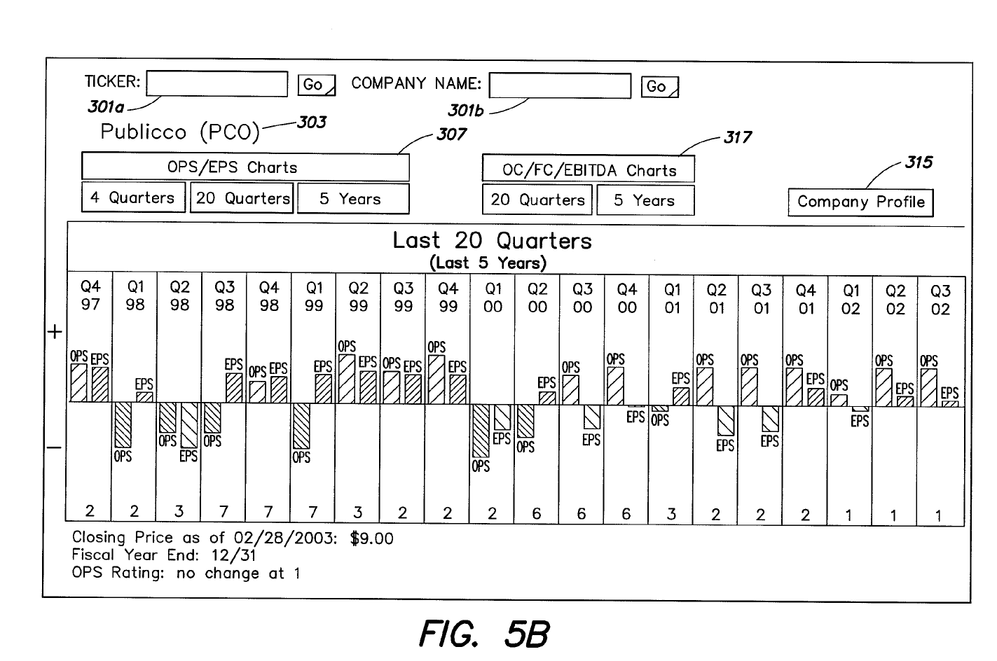

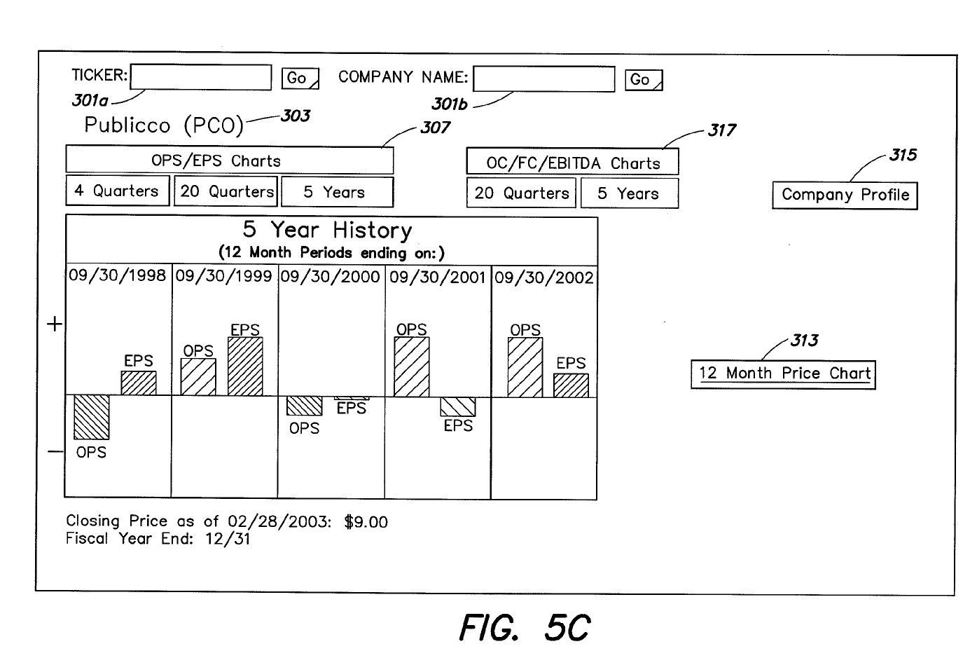

In one embodiment, the data received from server 201 includes graphical representations of financial metrics. The graphical representations could also include information about the relationship between these metrics. One embodiment of video screen displays, for accepting input and displaying the results, as shown in FIG. 5, is as follows. Boxes 301a and 301b are input fields which allow a user to enter a stock symbol or company name, respectively, about which he wishes to retrieve information (in the illustration, the fictitious company Publicco and symbol PCO are shown). After entering the stock or company identification, the user, via the client, may send a request to server 201 to obtain information about the company. In response, Server 201 receives the information from databases 203 or from a local cache or other source and formats the document for sending. The sent document includes box 303 which includes company information. The company information may be any general information about the company, such as the company's name (here, PUBLICCO), stock price, primary place of business, etc. Box 305 contains a graphical depiction of the financial metrics. As discussed above, the financial metrics may be, for example, EPS and OPS. The graphical depictions of box 305 will be discussed in more detail below. Box 307 may be provided to allow a user to select a time period for the metrics shown in box 305. For example, by clicking on five years, a user can view EPS and OPS over a five-year period. Any number of different time periods can be made available for selection in box 307, and the time periods shown in FIG. 5 are given only as examples. Box 307 also may be omitted and a fixed time period used; or an open-ended time period may be used including all time since the company went public.

The display may also include a reference legend (not shown) which shows patterns of financial metrics for different categories of financial health to be viewed for comparison and as an aid to interpretation of the display in box 305. For example, the reference legends and corresponding composite graphs may show what OPS and EPS typically have looked like over a period of time for financially strong companies and for financially weak companies. Box 311 may be provided to show a fiscal health rating of a company, such as the OPS rating of the company, based on the financial metrics. Such a rating may be presented in various ways other than showing an OPS rating. For example, it may be numerical, a letter grade, or an icon (e.g. a “thumbs up”, a “thumbs down”, or a “thumbs sideways” symbol). The fiscal health rating will be discussed in more detail below. Box 313 may link to a display of a stock price chart for the company over a period of time. Box 315 may link to a display which includes other desired information about the company, such as links to recent news stories about the company and company history. Box 317 may change the display to compare operating cash flow to other financial metrics. For example, operating cash (OC) flow may be compared with free cash flow (FC) and earnings before interest, tax, depreciation, and amortization (EBITDA).

FIG. 5B is similar to FIG. 5A, except that the OPS and EPS are compared over twenty quarters instead of four. The OPS rating for each quarter is shown at the bottom of the chart. Comparing over twenty quarters may allow one to determine how seasonality or the particular time of year affects a company's OPS and EPS. FIG. 5C shows a comparison of EPS and OPS over five years. The five year display may allow a user to evaluate the long term performance of a company.

Another advantage of this format of displaying information, is that it can be easily displayed in different languages. Since most of the content is graphical and the words describing the graphical depictions can easily be translated into a predetermined set of languages, display in many different languages can be accommodated with minimal processing, thus making the information usable for a wide cross-section of people.

It should be understood that the format of display shown in FIG. 5 is given only as an example. Many other arrangements and formats of the information can easily be contemplated by one skilled in the art and are intended to be within the scope and spirit of the invention. Additionally, it is not required that all the information discussed in relation to FIG. 5 be included in the display and there may be additional information not shown in FIG. 5 which could be included in the display. For example, it is not required that the reference legend and fiscal health rating be displayed, so long as the financial metrics are presented in some fashion.

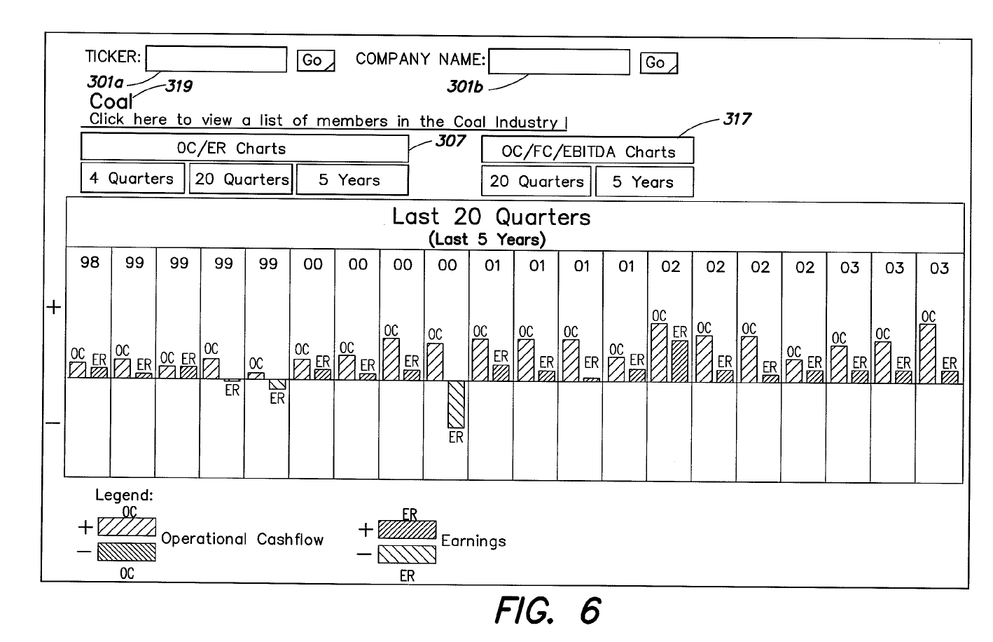

FIG. 6 is a display which includes a comparison of Operating Cash Flow and Earnings across an industry. In the example of FIG. 6, the coal industry is shown. Such a chart may be used to determine the overall health of an entire industry. This information may be useful to a user in determining whether to invest in a particular company that is a member of that industry. Like the charts for a particular company, the charts for a particular industry may also be viewed over a selected period of time, such as four quarters, twenty quarters, or five years. In the example of FIG. 6A, the twenty quarter chart is shown. Additionally, operating cash flow may also be compared with other financial metrics, such as FC and EBITDA.

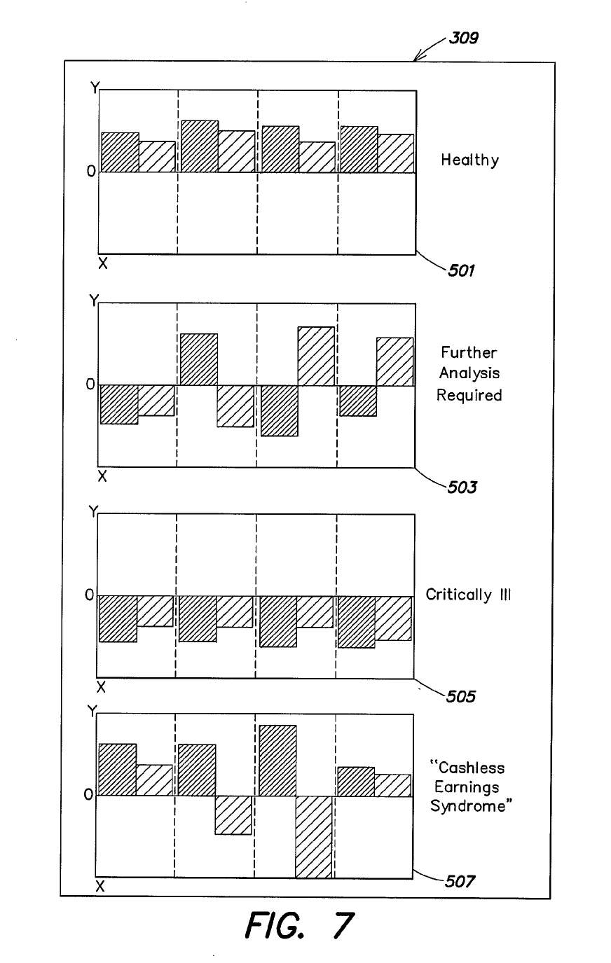

A more detailed depiction of the contents of the optional reference legend for displaying patterns of the financial metrics for different categories of financial health is shown in FIG. 7. In this example, patterns are given for a healthy company (chart 501), a company whose health requires more analysis (chart 503), a critically ill company (chart 505), and a company exhibiting Cashless Earnings Syndrome (chart 507). The pattern may be determined by analyzing a predetermined set of companies and using the average, median, or other values of the data. These charts may be generated dynamically, by calculating the values every time information is requested, or they may be static and updated periodically, such as every quarter. A user can visually compare the financial metrics displayed in box 305, for the company about which he has requested information, to the patterns in the reference legend box. Additionally, an automatic comparison may be performed, with the best match to a legend category then brought to a viewer's attention. For example, the border or background of the chart that most closely matches may be highlighted, changed to different color, or caused to flash on and off. Other types of indicators may also be used to indicate the results of the diagnosis.

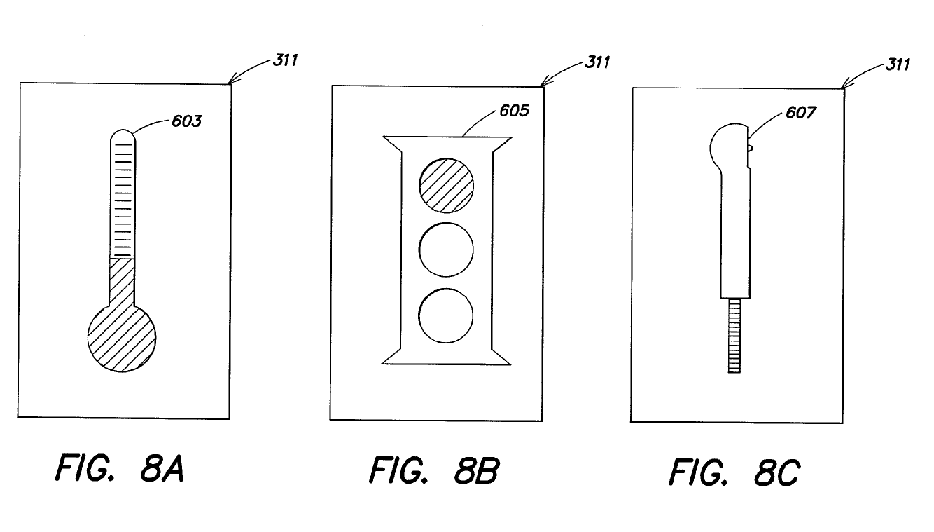

FIGS. 8A-8C show three different embodiments of box 311, which displays information about the relationship between the financial metrics. These displays may be substituted for or used in conjunction with the OPS Rating shown in box 311 of FIG. 5A. For example, referring to FIG. 8A, a picture of a thermometer 603 is shown. If the relationship between the financial metrics indicates that a company is financially strong, the “temperature” indicated by the thermometer will be high. If the company appears to be financially weak based on the relationship, the “temperature” will be low. Other measurement devices besides a thermometer could also be depicted. For example, in FIG. 8C, a tire air pressure gauge 607 is shown. High air pressure could indicate a company is fiscally strong and low air pressure could indicate a company is weak. While the thermometer and tire gauge can indicate the financial status of a company in a continuum, another embodiment indicates the financial status of a company in a finite number of discrete states. For example, in FIG. 8B, a traffic light 605 is depicted. The top light could be colored green to indicate that a company is financially strong, the middle light could be colored amber to indicate that the company may be in financial danger, and the bottom light could be colored red to indicate that the company is in financial trouble. It should be understood that these metrics and measurement devices, or indicators, are given only as examples. Numerous other metrics, measurement devices and indicators could be used and are intended to be within the spirit and scope of the invention.

Having thus described an exemplary implementation of the invention, it will be apparent now that one may determine a company's financial health by relating two or more different financial metrics. Numerous other implementations may occur readily to one skilled in the art and are intended to be within the spirit and scope of the invention. The invention is limited only as defined in the following claims and equivalents thereto.

What is claimed is:

1. A method for evaluating financial health of a public company comprising:
determining a relation between a value of a first financial indicator over a first period of time and second financial indicator over a second period of time.

2. The method of claim 1, wherein the first financial indicator is earnings of the company and the second financial indicator is operating cash flow of the company.

3. The method of claim 2, further comprising
determining a relation between earnings per share of stock of the company over a first period of time and operating cash flow per share of stock of the company over a second period of time.

4. The method of claim 2, further comprising:
determining if the earnings of the company over the first period of time are record earnings over a predetermined substantial period of time and if the operating cash flow of the company over a second period of time is negative by a value greater than the earnings.

5. The method of claim 4, wherein the predetermined substantial period of time is greater than the first and second periods of time.

6. The method of claim 1, wherein the first period of time is a fiscal quarter and the second period of time is a subsequent fiscal quarter.

7. The method of claim 4, further comprising:
determining an amount of debt of the company; and
evaluating the relation based on the amount of debt.

8. The method of claim 3, further comprising displaying a graphical representation of the relation.

9. The method of claim 3, further comprising displaying a graphical representation of values of the first fiscal indicator and values of the second fiscal indicator.

10. The method of claim 9, wherein the graphical representation is a histogram.

11. The method of claim 9, further comprising displaying with the graphical representation of the relation a diagnostic legend showing at least one pattern of earnings and operating cash flow indicative of a category of financial health.

12. The method of claim 11, further comprising:
making a comparison of the relation and the at least one pattern.

13. The method of claim 1, further comprising receiving the first fiscal data and the second fiscal of the company over a communications network.

14. The method of claim 9, further comprising allowing access to the graphical representation over a communications network.

15. The method of claim 1, further comprising displaying the first fiscal data and the second fiscal data in a language selected from among a predetermined set of a plurality of available languages.

16. An apparatus for evaluating financial health of a company comprising:
means for receiving financial data of the company; and
means for determining, in response to the financial data of the company, a relation between a value of a first financial indicator over a first period of time and a value of a second financial indicator over a second period of time.

17. The apparatus of claim 16, further comprising:
a graphical representation of the relation;

18. The apparatus of claim 16, further comprising:
a graphical representation of values of the first financial indicator and values of the second financial indicator.

19. The apparatus of claim 18, wherein the graphical representation is a histogram.

20. The apparatus of claim 18, wherein the graphical representation is part of a dynamically generated HTML document.

21. The apparatus of claim 18, wherein the graphical representation includes a diagnostic legend showing at least one pattern of earnings and operating cash flow indicative of a category of financial health.

22. The apparatus of claim 16, further comprising at least one data feed for providing the value of the first financial indicator over the first period of time and the value of the second financial indicator over the second period of time.

23. The apparatus of claim 16, further comprising a computer server for providing access to the value of the first financial indicator over the first period of time and the value of the second financial indicator over the second period of time over a communications network.

24. A computer-readable medium encoded with instructions for execution on a computer system, the instructions when executed performing a method comprising an act of:
determining a relation between a value of a first financial indicator over a first period of time and second financial indicator over a second period of time.

25. The computer-readable medium of claim 24, wherein the first financial indicator is earnings of the company and the second financial indicator is operating cash flow of the company.

26. The computer-readable medium of claim 24, wherein the method further comprises an act of:
determining a relation between earnings per share of stock of the company over a first period of time and operating cash flow per share of stock of the company over a second period of time.

27. The computer-readable medium of claim 25, wherein the method further comprises an act of:
determining if the earnings of the company over the first period of time are record earnings over a predetermined substantial period of time and if the operating cash flow of the company over a second period of time is negative by a value greater than the earnings.

28. The computer-readable medium of claim 27, wherein the predetermined substantial period of time is greater than the first and second periods of time.

29. The computer-readable medium of claim 24, wherein the first period of time is a fiscal quarter and the second period of time is a subsequent fiscal quarter.

30. The computer-readable medium of claim 27, wherein the method further comprises acts of
determining an amount of debt of the company; and
evaluating the relation based on the amount of debt.

31. The computer-readable medium of claim 26, wherein the method further comprises an act of displaying a graphical representation of the relation.

32. The computer-readable medium of claim 26, wherein the method further comprises an act of displaying a graphical representation of values of the first fiscal indicator and values of the second fiscal indicator.

33. The computer-readable medium of claim 32, wherein the graphical representation is a histogram.

34. The computer-readable medium of claim 32, wherein the method further comprises an act of displaying with the graphical representation of the relation a diagnostic legend showing at least one pattern of earnings and operating cash flow indicative of a category of financial health.

35. The computer-readable medium of claim 34, wherein the method further comprises an act of:
making a comparison of the relation and the at least one pattern.

36. The computer-readable medium of claim 24, wherein the method further comprises an act of receiving the first fiscal data and the second fiscal of the company over a communications network.

37. The computer-readable medium of claim 32, wherein the method further comprises an act of allowing access to the graphical representation over a communications network.

38. The computer-readable medium of claim 24, wherein the method further comprises displaying the first fiscal data and the second fiscal data in a language selected from among a predetermined set of a plurality of available languages.

39. In a computer system having a display, a method comprising performing acts of:
displaying, on the display, earnings per share of a preselected company over a period of time; and
displaying, on the display, operational cash flow of the company over the period of time.

40. The method of claim 39, further comprising an act of:
displaying, on the display, a fiscal health rating of the company, based on the earnings per share and the operational cash flow per share of the company.

41. The method of claim 39, further comprising an act of:
displaying, on the display, an amount of debt of the company.

42. The method of clam 39, further comprising, an act of:
displaying a reference legend that includes patterns of earnings per share and operation cash flow per share for different categories of financial health.

43. A computer-implemented method for evaluating financial health of a public company comprising:
receiving, electronically, values for first and second financial indicators of the company's performance; and
determining a relation between a value of a first financial indicator over a first period of time and second financial indicator over a second period of time.

44. The computer-implemented method of claim 43, wherein the first financial indicator is earnings of the company and the second financial indicator is operating cash flow of the company.

45. The computer-implemented method of claim 44, further comprising
determining a relation between earnings per share of stock of the company over a first period of time and operating cash flow per share of stock of the company over a second period of time.

46. The computer-implemented method of claim 44, further comprising:
determining if the earnings of the company over the first period of time are record earnings over a predetermined substantial period of time and if the operating cash flow of the company over a second period of time is negative by a value greater than the earnings.

47. The computer-implemented method of claim 46, wherein the predetermined substantial period of time is greater than the first and second periods of time.

48. The computer-implemented method of claim 43, wherein the first period of time is a fiscal quarter and the second period of time is a subsequent fiscal quarter.

49. The computer-implemented method of claim 46, further comprising:
determining an amount of debt of the company; and
evaluating the relation based on the amount of debt.

50. The computer-implemented method of claim 45, further comprising displaying a graphical representation of the relation.

51. The computer-implemented method of claim 45, further comprising displaying a graphical representation of values of the first fiscal indicator and values of the second fiscal indicator.

52. The computer-implemented method of claim 51, wherein the graphical representation is a histogram.

53. The computer-implemented method of claim 51, further comprising displaying with the graphical representation of the relation a diagnostic legend showing at least one pattern of earnings and operating cash flow indicative of a category of financial health.

54. The computer-implemented method of claim 53, further comprising:
making a comparison of the relation and the at least one pattern.

55. The computer-implemented method of claim 42, further comprising receiving the first fiscal data and the second fiscal of the company over a communications network.

56. The computer-implemented method of claim 51, further comprising allowing access to the graphical representation over a communications network.

57. The computer-implemented method of claim 43, further comprising displaying the first fiscal data and the second fiscal data in a language selected from among a predetermined set of a plurality of available languages.
